(19) United States
(12) Patent Application Publication
(10) Pub. No.: US 2013/0203891 A1
(43) Pub. Date: Aug. 8, 2013

(54) AQUEOUS DRAG REDUCERS FOR ARCTIC CLIMATES

(71) Applicant: PHILLIPS 66 COMPANY, Houston, TX (US)

(72) Inventors: Timothy L. Burden, Ponca City, OK (US); Kenneth W. Smith, Tonkawa, OK (US)

(73) Assignee: PHILLIPS 66 COMPANY, Houston, TX (US)

(21) Appl. No.: 13/756,694

(22) Filed: Feb. 1, 2013

Related U.S. Application Data
(60) Provisional application No. 61/594,156, filed on Feb. 2, 2012.

(51) Int. Cl. C08K 5/053

(52) U.S. Cl. CPC C08K 5/053
USPC 523/175

(57) ABSTRACT

An aqueous drag reducer comprising a poly(alpha olefin), a winterizing agent and water. In this embodiment the winterizing agent comprises at least about 30 wt % of the aqueous drag reducer. Additionally, water comprises less than about 2.0 times the amount of winterizing agent.

### CROSS-REFERENCE TO RELATED APPLICATIONS

This application is a non-provisional application which claims the benefit of and priority to U.S. Provisional Application Ser. No. 61/594,156 filed Feb. 2, 2012, entitled “Aqueous Drag Reducers for Arctic Climates,” which is hereby incorporated by reference in its entirety.

### STATEMENT REGARDING FEDERALLY SPONSORED RESEARCH OR DEVELOPMENT

None.

### FIELD OF THE INVENTION

This invention relates to the formation of aqueous drag reducers for arctic climates.

### BACKGROUND OF THE INVENTION

Petroleum as it is produced from underground oil formations is often difficult to handle, particularly in cold weather. For example, it is common that paraffin deposition and/or increased viscosity or pour point can render pumping difficult. Similarly, handling difficulties frequently persist in liquids derived from petroleum, such as automotive oils, certain fuels and lubricating oil.

As a result, non-aqueous drag reducer formulations are typically used for these extreme cold temperatures, but the cost of non-aqueous drag reducers can be quite high.

U.S. Pat. No. 6,100,221 first attempted to solve this problem by using a crystal modifier. However the use of the crystal modifier caused the viscosity of the drag reducer to be greater than 5,000 cP. This effectively made their patent incapable of being utilized as a drag reducer.

U.S. Pat. No. 5,539,044 was one of the first patents to utilize an aqueous type system to solve the problem of costly non-aqueous drag reducers. However the limit of up to 30 wt % alcohol made this drag reducer incapable of flowing in freezing temperatures.

US Patent Application 2007/0205392 attempted to improve upon U.S. Pat. No. 5,539,044 by limiting the amount of wetting agents they utilized. By restricting the amount of wetting agents, the use of cheap and conventional thickeners was unusable. There exists a need for an aqueous drag reducer capable of operating in cold temperatures without modifying the viscosity of the fluid that is being flowed.

### BRIEF SUMMARY OF THE DISCLOSURE

An aqueous drag reducer comprising a poly(alpha olefin), a winterizing agent and water. In this embodiment the winterizing agent comprises at least about 30 wt % of the aqueous drag reducer. Additionally, water comprises less than about 2.0 times the amount of winterizing agent.

In yet another embodiment an aqueous drag reducer is taught comprising a poly(alpha olefin), a winterizing agent, an additive package and water. In this embodiment the winterizing agent comprises at least about 30 wt % of the aqueous drag reducer and water comprises less than about 1.5 times the amount of winterizing agent. The additive package is capable of lowering the freezing point of the mixture comprising the poly(alpha olefin), the winterizing agent and water. Additionally, in this embodiment the aqueous drag reducer does not become solid at freezing temperatures.

In yet another embodiment a method is taught of mixing a mixture comprising a winterizing agent, a poly(alpha olefin) and water to produce an aqueous drag reducer. In this embodiment the water comprises about 2.0 times the amount of winterizing agent by weight and the winterizing agent comprises at least about 30 wt % of the aqueous drag reducer.

### BRIEF DESCRIPTION OF THE DRAWINGS

A more complete understanding of the present invention and benefits thereof may be acquired by referring to the follow description taken in conjunction with the accompanying drawings in which:

None

### DETAILED DESCRIPTION

In one embodiment an aqueous drag reducer is formed by combining a winterizing agent, water and a poly(alpha olefin). In this embodiment the amount of water added is at least 20 wt % of the aqueous drag reducer. Additionally, the aqueous drag reducer does not form ice crystals at freezing temperatures.

Freezing temperatures are generally termed as temperatures in which the aqueous drag reducer, if it was made absent the winterizing agent, would become a solid. This temperature is typically 0° C. The addition of the wintering agent can extend the freezing temperature of the aqueous drag reducer to below −17° C., −40° C. or even −50° C.

The present embodiment utilizes a winterizing agent. Non-limiting examples of the winterizing agent can include alcohols, glycols, diols, or glycol ethers including those that generally contain a hydroxyl group or multiple hydroxyl groups. Such alcohols, glycols, diols, or glycol ethers may be selected from, in non-limiting embodiments, methanol, ethanol, propanol, isopropanol, butanol, ethylene glycol, propylene glycol, butylene glycol, hexylene glycol, diethylene glycol, dipropylene glycol, triethylene glycol, tripropylene glycol, propylene glycol methyl ether, dipropylene glycol methyl ether, tripropylene glycol methyl ether, propylene glycol propyl ether, dipropylene glycol propyl ether, tripropylene glycol propyl ether, propylene glycol butyl ether, dipropylene glycol butyl ether, tripropylene glycol butyl ether, propylene glycol phenyl ether, dipropylene glycol dimethyl ether, diethylene glycol ethyl ether, diethylene glycol methyl ether, diethylene glycol butyl ether, diethylene glycol hexyl ether, ethylene glycol propyl ether, ethylene glycol butyl ether, ethylene glycol hexyl ether, triethylene glycol methyl ether, triethylene glycol ethyl ether, triethylene glycol butyl ether, ethylene glycol phenyl ether, ethylene glycol ethyl ether, polyethylene glycol, monosaccharide, polypropylene glycol, and copolymer of polypropylene and polyethylene glycol mixtures thereof, and the like. Other winterizing agents that can be used include dimethyl sulfoxide, glycerine and the like. In another embodiment the winterizing agent is a blend of two or more of the winterizing agents described above.

The aqueous drag reducer can contain at least 20 wt % of the winterizing agent. In other embodiments the winterizing agent is at least 30 wt %, 35 wt %, 40 wt %, 45 wt %, 50 wt %, 55 wt % even over 60wt % of the aqueous drag reducer. In other embodiments the upper limit of the winterizing agent can be 75 wt %, 70 wt %, 65 wt %, 60 wt % even 55 wt % of the aqueous drag reducer.

Water can be present in the aqueous drag reducer in an amount less than 2.0 times the winterizing agent by weight. In other embodiments, the water can be present in amounts less than 1.9, 1.8, 1.7, 1.6, 1.5 even 1.4 times the winterizing agent by weight.

In one embodiment the poly(alpha olefin)s are any known poly(alpha olefin) that can impart drag reduction. Poly(alpha olefin)s are, in some embodiments, ultra-high molecular weight poly alpha olefins that have been formed by polymerization of a selected alpha olefin monomer or combinations of alpha olefin monomers. Ultra-high molecular weight can mean the drag reducing agents have a number average molecular weight greater than about 1 million, and in some embodiments from about 20 million to about 35 million, or higher. This polymerization of the drag reducing agent can be done by any conventionally known method. Examples of some method include solution polymerization, wherein the drag reducing agent is precipitated from the solution via addition of a non-solvent component, or a bulk polymerization wherein no solvent is included. Additional methods of creating poly(alpha olefin)s are taught in U.S. Pat. No. 5,539,044 incorporated herein by reference.

The present embodiment can also utilize an additive package. The additive package can contain any known additives such as a fatty acid, buffering agent, antifoam, thickener or a partitioning agent. In one embodiment the additive package can range from 5 wt % to 20 wt % of the aqueous drag reducer. In yet another embodiment the additive package can be capable of lowering the freezing point of the mixture comprising the poly(alpha olefin), the winterizing agent and water.

As stated previously the additive package can also utilize any known partitioning agent. Examples of partitioning agents include calcium stearate, alumina, talc, clay, tri-calcium phosphate, magnesium stearate, polyanhydride polymers, sterically hindered alkyl phenol oxidants, graphite, and various stearamides. Partitioning agents should be compatible with the hydrocarbon fluid the aqueous drag reducer is utilized in and should be non-reactive or minimally reactive with the polymer, suspending fluid, and grinding aid.

As stated previously the additive package can also include fatty acid waxes. This fatty acid wax may be selected from the group consisting of fatty acids, fatty acid salts, fatty acid esters, and fatty acid amides. In one non-limiting embodiment, these include Groups 1, 2, 12, and 13 (IUPAC standard notation) metal salts of stearic acid; stearic acid amides; and stearic acid esters. Such may include, for example, magnesium stearate, calcium stearate, zinc stearate, aluminum stearate, sodium stearate, and potassium stearate, as well as ethylene bis-stearamide, stearamide, ethylene glycol monostearate, ethylene glycol distearate, propylene glycol monostearate, propylene glycol distearate, glycerol stearate, glycerol distearate, glycerol tristearate, diethylene glycol distearate, stearic anhydride, and combinations thereof. “Stearic acid” and “stearates”, as used herein, refer, respectively, to fatty acids and fatty acid derivatives containing a range of carbon chain lengths, provided that the compound meets the definition of a wax, i.e., is solid at ambient temperature. They may be either saturated or unsaturated compounds. In some non-limiting embodiments chain lengths from about C10 to about C24 may be selected. In other non-limiting embodiments a carbon chain length of about C18 may be effectively selected.

As stated previously the additive package can also include surfactants. Any known surfactant can be utilized, particularly ionic surfactants. Examples of suitable ionic surfactants include, but are not limited to, anionic surfactants such as alkyl carboxylates, alkyl ether carboxylates, alkyl sulfates, alkyl ether sulfates, alkyl sulfonates, alpha.-olefin sulfonates, alkyl ether sulfates, alkyl phosphates and alkyl ether phosphates. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Examples of suitable ionic surfactants also include, but are not limited to, surfactants that are usually regarded as zwitterionic surfactants and in some cases as amphoteric surfactants such as alkyl betaines, alkyl amido betaines, alkyl amido sultaines, alkyl imidazolines, alkyl amine oxides and alkyl quaternary ammonium carboxylates. The amphoteric surfactant is a class of surfactant that has both a positively charged moiety and a negatively charged moiety over a certain pH range (e.g. typically slightly acidic), only a negatively charged moiety over a certain pH range (e.g. typically slightly alkaline) and only a positively charged moiety at a different pH range (e.g. typically moderately acidic), while a zwitterionic surfactant has a permanently positively charged moiety in the molecule regardless of pH and a negatively charged moiety at alkaline pH. In some embodiments, the surfactant is a cationic, zwitterionic or amphoteric surfactant containing and amine group or a quaternary ammonium group in its chemical structure (“amine functional surfactant”). In another embodiment the surfactant is a blend of two or more of the surfactants described above, or a blend of any of the surfactant or surfactants described above with one or more nonionic surfactants.

In one embodiment the amount of surfactant used could range from 0.01 wt % to over 5 wt % of the aqueous drag reducer. In alternate embodiments it can be envisioned that the amount of surfactant used is greater than 2 wt %, greater than 3 wt %, and even greater than 5 wt % than the aqueous drag reducer.

In one embodiment stability of the aqueous drag reducer can be improved by increasing the viscosity of the water phase, but it is desirable that the viscosity of the final slurry be sufficiently low to flow by gravity to an injection pump for insertion into the flowing hydrocarbon stream. In order to increase the viscosity of the slurry, one or more water-soluble polymers can be employed. Some examples of such suitable water-soluble polymeric thickening agents include guar gum, guar gum derivatives, hydroxymethyl cellulose, xanthan gums, hydroxyethyl cellulose, polyacrylamides, hydroxypropyl cellulose, modified starches, and polysaccharides. The thickener added can be any amount less than 0.5wt % of the aqueous drag reducer. In one embodiment the thickener is added from 0.01 wt % to 0.5 wt %.

Other additive package ingredients can also be added such as antifoam, buffering agents, fatty acids, preservatives, biocides, fungicides, algaecides, mold inhibitors, corrosion inhibitors, scale inhibitors, colorants, dyes, and mixtures thereof. In some embodiments the antifoam can be present in amounts less than 2 wt % or even 1 wt %. In other embodiments the fatty acid and the buffering agent can be present in amount ranging from 1 wt % to 3 wt %.

In one non-limiting embodiment the formulation of the aqueous drag reducer could be:

TABLE 1

| | | Narrower |
|---|---|---|
| Ingredient | Range | Range |
| Water | 20-45 wt % | 30-40 wt % |
| Winterizing Agent | 30-45 wt % | 30-40 wt % |
| Poly(alpha olefin) | 8-35 wt % | 10-30 wt % |
| Additive Package | 5-20 wt % | 4-15 wt % |
| (Partitioning agents, | | |
| thickeners, buffering | | |
| agents, fatty acids, | | |
| etc . . . ) | | |

In one embodiment the water, winterizing agent and the poly(alpha olefin) are mixed together in ambient temperatures. Ambient temperatures can be described as less than boiling temperatures. For example, ambient temperatures are less than 70° C., 60° C., 50° C., even less than 40° C.

In one embodiment the aqueous drag reducer is freeze thaw stable. Freeze thaw stability tests usually consist of freezing a drag reducer then thawing it out. At the end of this freeze thaw test, the aqueous drag reducer should not have any significant change in the physical characteristics or its ability to operate as a drag reducer.

The following examples of certain embodiments of the invention are given. Each example is provided by way of explanation of the invention, one of many embodiments of the invention, and the following examples should not be read to limit, or define, the scope of the invention.

### Example 1

### Suspension A

In one embodiment the procedure for producing the aqueous drag reducer is produced by mixing the following ingredients.

TABLE 2

| Ingredient | Range | |
|---|---|---|
| Water | 20-40 | wt % |
| Fatty Acid | 1-3 | wt % |
| Buffering Agent | 1-3 | wt % |
| Winterizing Agent | 30-40 | wt % |
| Antifoam | <2 | wt % |
| Thickener | <0.5 | wt % |
| Poly(alpha olefin) | 10-30 | wt % |
| Partitioning Agent | 2-15 | wt % |

Different winterizing agents were used in the Suspension A. Table 3 lists the different winterizing agents used and the associated viscosity of the winterizing agents. Fann viscosity (high-shear viscosity) was taken at 511 s⁻¹ and Brookfield viscosity (low-shear viscosity) was taken with 30 rpm. The units for the Brookfield viscosity and the Fann viscosity are in cP.

TABLE 3

| Sam- | | As-Made | | 1 week | | 5 weeks | |
|---|---|---|---|---|---|---|---|
| ple | Winterizing | Fann | BF | Fann | BF | Fann | BF |
| ID | Agent | Visc | Visc | Visc | Visc | Visc | Visc |
| 1 | propylene glycol | 320 | 2148 | N/M | 18000 | 441 | 11518 |
| 2 | dimethyl | 217 | 4159 | 147 | 1968 | 240 | 4071 |
| | sulfoxide | | | | | | |
| 3 | ethylene glycol | 267 | 1540 | 228 | 1932 | 251 | 2024 |
| 4 | glycerine | 452 | 1876 | 336 | 3363 | 300 | 1960 |
| 5 | diethylene glycol | 300 | 2020 | 185 | 1844 | 496 | 14157 |
| 6 | triethylene glycol | 237 | 1460 | 146 | 1764 | N/M | 15617 |
| 7 | methanol | 41 | 412 | Too thick to measure. Semi- | | | |
| 8 | ethanol | 52 | 803 | Solid | | | |
| 9 | isopropanol | 71 | 1288 | 105 | 2979 | 129 | 3847 |

### Example 2

### Suspension B

As shown in Table 4, formulations were created with varying ratios of water to winterizing agent ratios. The freezing point of water/glycol mixtures and of drag reducer formulations using the same water/glycol mixtures were measured using differential scanning calorimetry (DSC). This allowed for a lower ratio of winterizing agent in the aqueous drag reducer. Each of these formulations are freeze thaw stable. As shown below the ratio of water to winterizing agent can be greater than 4.00, 3.00, 2.33, 1.86, 1.50, 1.22, 1.00, 0.82 or 0.67. Although not shown it can also be greater than 0.60 or even 0.50. Alternatively, the ratio of water to winterizing agent can be between any number previously mentioned, such as between 4.00 to 0.50 or even 4.00 to 0.60.

TABLE 4

| Component | wt % | wt % | wt % | wt % | wt % | wt % | wt % | wt % | wt % |
|---|---|---|---|---|---|---|---|---|---|
| Water | 49.79 | 46.68 | 43.57 | 40.46 | 37.34 | 34.23 | 31.12 | 28.01 | 24.90 |
| Buffer | 1.00 | 1.00 | 1.00 | 1.00 | 1.00 | 1.00 | 1.00 | 1.00 | 1.00 |
| Winterizing Agent | 12.45 | 15.56 | 18.67 | 21.78 | 24.90 | 28.01 | 31.12 | 34.23 | 37.34 |
| Surfactant | 0.70 | 0.70 | 0.70 | 0.70 | 0.70 | 0.70 | 0.70 | 0.70 | 0.70 |
| Fatty Acid | 1.20 | 1.20 | 1.20 | 1.20 | 1.20 | 1.20 | 1.20 | 1.20 | 1.20 |
| Poly(alpha olefin) | 32.86 | 32.86 | 32.86 | 32.86 | 32.86 | 32.86 | 32.86 | 32.86 | 32.86 |
| Antifoam | 1.50 | 1.50 | 1.50 | 1.50 | 1.50 | 1.50 | 1.50 | 1.50 | 1.50 |
| Thickener | 0.50 | 0.50 | 0.50 | 0.50 | 0.50 | 0.50 | 0.50 | 0.50 | 0.50 |
| Total % | 100 | 100 | 100 | 100 | 100 | 100 | 100 | 100 | 100 |
| Water/Winterizing | 4.00 | 3.00 | 2.33 | 1.86 | 1.50 | 1.22 | 1.00 | 0.82 | 0.67 |
| Agent Ratio | | | | | | | | | |
| % Winterizing | 20 | 25 | 30 | 35 | 40 | 45 | 50 | 55 | 60 |
| Agent in water | | | | | | | | | |
| carrier | | | | | | | | | |
| Measured | 19.9 | 14.3 | 7.9 | 0.7 | −7.6 | −17.3 | −34.1 | −43.1 | N/M |
| Water/Glycol | | | | | | | | | |
| Freeze Point (° F.) | | | | | | | | | |
| Measured | 17.6 | 12.4 | 5.5 | −1.8 | −12.0 | −19.9 | −31.3 | −43.6 | −53.5 |
| Suspension | | | | | | | | | |
| Freeze Point (° F.) | | | | | | | | | |

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. An aqueous drag reducer comprising:
a poly(alpha olefin);
a winterizing agent comprising at least about 30 wt % of the aqueous drag reducer; and
water comprising less than about 2.0 times the amount of winterizing agent by weight.

2. The aqueous drag reducer of claim 1, wherein the aqueous drag reducer does not become a solid at freezing temperatures.

3. The aqueous drag reducer of claim 1, wherein the aqueous drag reducer is mixed together in ambient temperatures.

4. The aqueous drag reducer of claim 3, wherein ambient temperatures are temperatures less than 70° C.

5. The aqueous drag reducer of claim 1, wherein the winterizing agent comprises at least about 35 wt % of the aqueous drag reducer.

6. The aqueous drag reducer of claim 1, wherein the water comprises less than about 1.5 times the amount of winterizing agent by weight.

7. The aqueous drag reducer of claim 1, wherein the winterizing agent is an alcohol.

8. The aqueous drag reducer of claim 1, wherein the winterizing agent is selected from the group consisting of dimethyl sulfoxide, ethylene glycol, glycerine or isopropanol.

9. The aqueous drag reducer of claim 1, wherein the winterizing agent is selected from the group consisting of: polyethylene glycol, polypropylene glycol, copolymer of ethylene glycol and propylene glycol and combinations thereof.

10. The aqueous drag reducer of claim 1, wherein the aqueous drag reducer does not become a solid at −17° C.

11. The aqueous drag reducer of claim 1, wherein the aqueous drag reducer is freeze thaw stable.

12. The aqueous drag reducer of claim 1, wherein the aqueous drag reducer comprises an additive package.

13. The aqueous drag reducer of claim 12, wherein the additive package lowers the freezing point of the aqueous drag reducer.

14. The aqueous drag reducer of claim 1, wherein the additive package comprises a partitioning agent.

15. The aqueous drag reducer of claim 14, wherein the additive package comprises at least 2 wt % of the aqueous drag reducer.

16. The aqueous drag reducer of claim 1, wherein the additive package comprises a thickener.

17. The aqueous drag reducer of claim 1, wherein the winterizing agent comprises less than about 70 wt % of the aqueous drag reducer.

18. An aqueous drag reducer comprising:
a poly(alpha olefin);
a winterizing agent comprising from about 30 wt % to about 70 wt % of the aqueous drag reducer;
water comprising less than about 1.5 times the amount of wintering agent by weight; and
an additive package capable of lowering the freezing point of the mixture comprising the poly(alpha olefin), the winterizing agent and water,
and wherein the aqueous drag reducer does not become a solid at freezing temperatures.

19. A method comprising:
mixing a mixture comprising: a winterizing agent, a poly(alpha olefin) and a water to produce an aqueous drag reducer; and
wherein the water comprises about 2.0 times the amount of winterizing agent by weight and the winterizing agent comprises at least about 30 wt % of the aqueous drag reducer.

20. The method of claim 19, wherein the mixture is mixed at an ambient temperature less than 70° C.

21. The method of claim 19, wherein the winterizing agent comprises at least 30 wt % of the aqueous drag reducer.

22. The method of claim 19, wherein the winterizing agent is an alcohol.

23. The method of claim 19, wherein the winterizing agent is selected from the group consisting of dimethyl sulfoxide, ethylene glycol, glycerine or isopropanol.

24. The aqueous drag reducer of claim 19, wherein the winterizing agent is selected from the group consisting of: polyethylene glycol, polypropylene glycol, copolymer of ethylene glycol and propylene glycol and combinations thereof.

25. The method of claim 19, wherein the aqueous drag reducer is freeze thaw stable.

26. The method of claim 19, wherein the aqueous drag reducer comprises an additive package.

27. The aqueous drag reducer of claim 26, wherein the additive package comprises from about 5 wt % to about 20 wt % of the aqueous drag reducer.
